(19) United States
(12) Patent Application Publication
(10) Pub. No.: US 2008/0307043 A1
(43) Pub. Date: Dec. 11, 2008

(54) METHOD AND ARCHITECTURE SUPPORTING HIGH PERFORMANCE WEB APPLICATIONS

(76) Inventors: Paul Raymond Dorsey, Colonia, NJ (US); Yalim Kerem Gerger, Levent Istanbul (TR)

Correspondence Address: PATTERSON & SHERIDAN L.L.P. NJ Office, 595 SHREWSBURY AVE, STE 100, FIRST FLOOR, SHREWSBURY, NJ, 07702, US

(21) Appl. No.: 12/113,322

(22) Filed: May 1, 2008

Related U.S. Application Data
(60) Provisional application No. 60/943,140, filed on Jun. 11, 2007.

(51) Int. Cl. G06F 17/30

(52) U.S. Cl. 709/203

(57) ABSTRACT

A method for architecting computer web applications where logic supporting the application is primarily stored in an application server. The client machine stores the current look of the application. Information concerning user interface events and data changes is transmitted from the client to the application server. The application server interprets those events, executes appropriate server-side actions and determines the appropriate user interface changes, which are transmitted from the application server to the client. The client then executes the user interface changes.

### CROSS REFERENCE TO RELATED APPLICATIONS

This application claims benefit of U.S. provisional patent application Ser. No. 60/943,140, filed Jun. 11, 2007, which is herein incorporated by reference.

### FIELD OF THE INVENTION

The present invention generally relates to relates web applications and, more particularly, to a method and architecture adapted to maximize performance by minimizing network traffic between a client computer and an application server.

### BACKGROUND OF THE INVENTION

Within the context of web applications such as Internet-based applications (e.g., so-called “Web 2.0” applications), reasonable performance is critical to meeting customer expectations. Unfortunately, many such applications have notoriously slow performance. Web pages may require many seconds or even minutes to load, even with a broadband connection. The greater the sophistication of the Web page in terms of functionality, imagery and the like, the longer the required load time at the client device. In general, the implementation of client side application logic requires a large amount of software code, further exacerbating the load time problem.

In traditional web-based applications, each time a web page is submitted by a client the entire page is transmitted from the client to the application server. To modify a page in most currently used technologies, the entire modified page or a large portion of the page is transmitted from the application server back to the client.

Generally speaking, most web applications are directed towards enhancing the functionality, capabilities and so on of the applications. While such efforts yield more capable applications, this capability comes with increased cost and complexity.

### SUMMARY OF THE INVENTION

Various deficiencies of the prior art are addressed by the present invention of a method and architecture adapted to maximize application performance by minimizing the amount of information that must be transmitted between a client device/computer and an application server.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a client server system according to one embodiment;

FIG. 2 depicts a flow diagram of a client-side method according to one embodiment;

FIG. 3 depicts a flow diagram of a server-side method according to one embodiment;

FIG. 4 depicts various user interface data entry screens useful in understanding the present invention; and

FIG. 5 depicts a flow diagram of a web application methodology according to one embodiment.

To facilitate understanding, identical reference numerals have been used, where possible, to designate identical elements that are common to the figures.

### DETAILED DESCRIPTION OF THE INVENTION

The subject invention will be primarily described within the context of web applications such as an Internet-based application in which user interface (UI) screens associated with a client-requested application are provided to the client by a server. The UI screens include fields that are updated or otherwise modified by user interaction with the client. Client-installed software components identify changes to (or commands associated with) the UI screens, and propagate to the server information sufficient to represent the changes or associated commands. However, it will be appreciated by those skilled in the art that the invention may be advantageously employed in any shared application processing system in which transmission and computational efficiencies may be realized by processing only update/difference portions of data sets rather than entire data sets. Moreover, while described with respect to user screens, the inventors contemplate that other portions of an application that may propagate partial information to a server or web application will benefit from the invention.

Generally speaking, the subject invention provides web and client-server application performance improvements by, illustratively, reducing client-server communication within the context of an application service provider by only transmitting essential information rather than transmitting entire web pages. Thus, when the user event occurs, such as the modification of the field, changed data item or other information at the client, only an notification of the modification or changed data are transmitted to the server. Similarly, when the server receives a UI or other event notification, only information relevant to UI or other changes are transmitted back to the client.

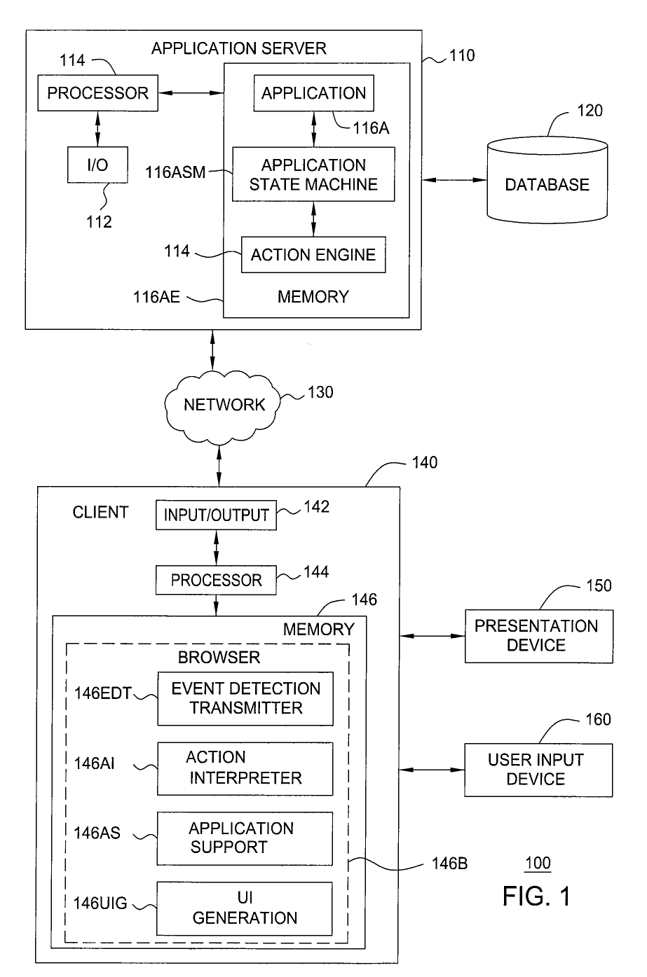

FIG. 1 depicts a high-level block diagram of a client server system according to one embodiment. Specifically, the system 100 of FIG. 1 comprises illustratively an application server 110, a data base 120, a network 130, a client device 140, a presentation device 150 and a user input device 160. The system 100 of FIG. 1 is depicted in a simple manner to more clearly explain the present invention. It will be appreciated by those skilled in the art that multiple application servers 110, multiple databases 120, multiple networks 130 and/or multiple clients 140 may be used within a system according to the teachings of the present invention. Thus, the simplified system 100 of FIG. 1 may be expanded in these and other way known to those skilled in the art, and such expansions are contemplated by the inventors.

The application server 110 is depicted as a general-purpose computer including input/output (I/O) circuitry 112, processor circuitry 114 and memory 116. The application server 110 communicates with at least one database 120 and with the network 130. The memory 116 stores, among other things, a server side portion of an application 11 6A, a corresponding application state machine 116ASM and a corresponding action engine 116AE. The various functional elements stored in/or described herein with respect to the memory 116 cooperate with each other and with other functional elements.

The application 11 6A may comprise any web application in which client-side user interaction with, for example, a user interface (UI) screen provides data intended to be processed at the server. The present invention is adapted to reducing data transport and other resource consumption by reducing the amount of data propagated between client and server devices within the context of supporting a particular application 116A. The application itself is to be broadly construed in this manner.

The application state machine 116ASM is used to store the current state of the application. Specifically, application state machine 116ASM stores information indicative of the current progress/usage of the application 116A for each client invoking the application. The application state machine 116ASM may be used to store variable states, passcodes/permissions, user identifications, documents in progress, session state and so on. In short, the application state machine 116ASM stores a snapshot of the state of an application being executed as of the last prior action.

The action engine 116AE receives notifications related to client-side events associated with the application (e.g., updates/changes to UI fields, a data input of the like). The action engine 116AE checks the current state of the application along with a set of application-specific rules to determine how the event should be processed. These application rules reside in a repository in one embodiment. In other embodiments, the application rules exist as application-specific code. The action engine 116AE performs appropriate code and database actions and then specifies one or more actions (if appropriate) to be executed by the client device, such as in the user interface (e.g., “set a field to a particular value”) or other portion of the client-side application. These actions are then transmitted back to the client computer.

Generally speaking, the action engine 16AE operates as a rules engine to determine which actions to take by comparing one or more sets of rules (application-derived rules or other rules) to received user input/updates, such as updates to UI fields, documents or other information, client requests and responses, the occurrence of particular conditions as indicated by the application state machine 116ASM and so on. In short, the action engine 116AE provides in the logic framework to process client information within the context of the currently executed application. Optionally, the action engine 116AE provides a logic framework to process information received from the application state machine 116ASM.

The data base 120 is depicted as being separate from the application server 110. However, the data base 120 may be integrated within the application server 110 or otherwise accessible to the application server 110 (e.g., part of another server or storage element accessible by the application server 110).

Various modifications to the embodiments discussed herein are contemplated by the inventor. For example, any of the application 116A, application state machine 116ASM and action engine 116AE functional elements may be implemented entirely within the application server 110, entirely within the data base 120 or distributed between the application server 110 and database 120. Broadly speaking, though depicted within FIG. 1 as being implemented in a particular manner, there is no requirement that these functional elements be implemented solely within the application server 110.

The network 130 may comprise, illustratively, an Internet Protocol (IP) network such as the Internet, and asynchronous transfer mode (ATM) network and so on. For purposes of this discussion it will be assumed that network 130 comprises the Internet.

The client 140 is depicted as a general-purpose computer including input/output (I/O) circuitry 142, processor circuitry 144 and memory 146. The client 140 communicates with a presentation device 150 (e.g., a display device and the like) and a user input device 160 (e.g., a keyboard, mouse, speech recognition device and the like). The memory 146 stores, among other things, a client side portion of an application 116A, an Event Detector/Transmitter 146EDT, and action interpreter 146AI, application support programs 146AS and a user interface (UI) generator 146UIG. Optionally, one or more of the functional elements operating within the memory 146 may be instantiated as plug-ins or applets within a browser 146B. The various functional elements stored in/or described herein with respect to the memory 146 cooperate with each other and with other functional elements.

In one embodiment, in response to a client device invoking a server-side application, a small code interpreter is instantiated in the client device while a logic engine is instantiated in the application server. Thus, the logic processing operations associated with the application are processed at the application server rather than at the client device, thereby saving client computational resources. Moreover, since the information necessary to trigger the various logic processing operations of the application tends to require less data and/or communication bandwidth, a reduction in transport resources is also achieved. Using this approach, all application logic resides on the server, and minimal information needs to be transmitted to support the application.

In one embodiment, the Event Detector/Transmitter 146EDT is coded in a programming language that can run on a client machine with a standard browser. Such programming languages include JavaScript, Macromedia's Flash or Flex and/or other standalone or applet-enabling languages. The Event Detector/Transmitter may be loaded when the application is first opened or be resident before the application is opened. In one embodiment, when a user opens an application using this invention for the first time, the Event Detector/Transmitter and Action Interpreter are downloaded to the client computer along with an initial user interface screen. Once installed on the client computer, these application components will remain resident on the client computer and remain unchanged throughout the running of the application. In a variation of the invention, the Event Detector/Transmitter 146EDT and Action Interpreter 146AI remain resident on the client computer long-term as a download such as the Macromedia extension or as a browser plug-in.

The Action Interpreter (which resides on the client computer) receives the actions from the application server and executes the appropriate user interface actions. The Action Interpreter software is written in any client programming language, such as the language used to create the Event Detector/Transmitter. The screen as rendered on the client machine has various components including: images, static text, data fields, selection items (list boxes, combo boxes, checkboxes, buttons etc.) and other user interactive items.

When user interface events of interest (e.g., a change for updating of a field, button or other object) or other (non-UI events of interest) are detected by the Event Detector/Transmitter 146EDT, the Action Interpreter 146AI transmits to an application server (or stores for subsequent transmission) the events of interest along with any field changes that have occurred since the last event of interest transmission.

Various modifications to the embodiments discussed herein are contemplated by the inventor. For example, any of the client side portion of an application 116A, Event Detector/Transmitter 146EDT, action interpreter 146AI, application support programs 146AS and user interface (UI) generator 146UIG may be installed persistently or instantiated when the need for the corresponding function arises. Thus, in one embodiment these functional elements are coded as Java Script and are loaded at the start of a user session.

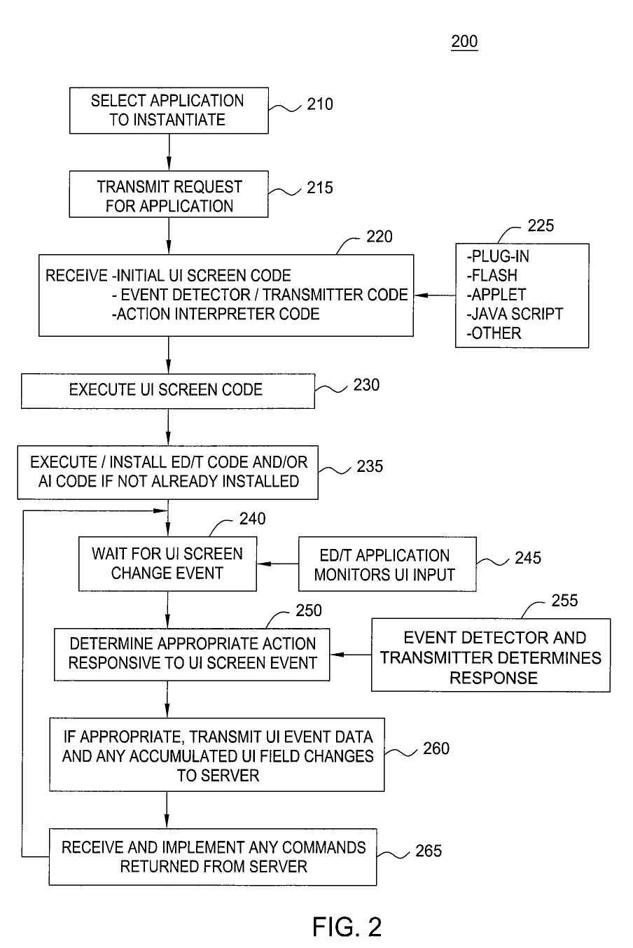

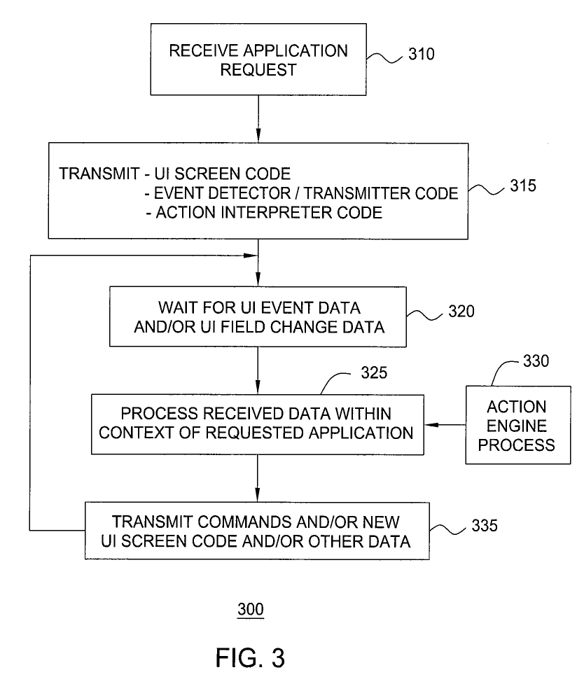

The operation of various application server functional elements and client device functional elements will now be described in more detail with respect to FIGS. 2 and 3. It is noted that the client side components and a server-side components operate in a relatively independent manner with respect to each other. While generally described herein within the context of a thin client, it is noted that client side components may be implemented as Thick Client Java (or some similar language), a standard web client (using JavaScript, Visual Basic or any other similar/supporting language), flash memory or any other architecture capable of supporting the event detector/transmitter, action interpreter and other functional elements. In multiple client embodiments, some clients within a population of client devices may use one implementation while other clients within the population of clients may use a different implementation. While generally described herein within the context of a specific server embodiment, the server functions may be implemented in an application server using Java or some similar language, implemented within a database using a source query language or relational database such as PL/SQL from Oracle Corp. of Redwood Shores, Calif. (or other similar environment), or split between the application server and database functional elements.

FIG. 2 depicts a flow diagram of a client-side method according to one embodiment. Specifically, the method 200 of FIG. 2 is entered at step 210 when an application to be instantiated is selected via a client device.

At step 215, a request for the application is transmitted to an application server from the client device. At step 220, the client device receives, illustratively, one or more of initial user interface screen software code, event detector/transmitter software code and action interpreter software code and other functional element software code. Referring to box 225, this code may comprise plug-in, flash, applet, JavaScript and/or other software code as appropriate, depending upon the particular implementation details of the software code environment supporting these functional elements. Specifically, there is not a particular need to install a plug-in or other persistent component, such an installation is merely contemplated as an option to improve performance according to alternate embodiments. However, in one embodiment, the client code is stored in a memory for subsequent use, such within a persistent structure (e.g., a browser cookie, extension and the like).

At step 230, user interface screen code is executed to provide thereby presentation device imagery. At step 235, event detector/transmitter code and/or action interpreter code is installed, if not already installed at the client, and executed. Within the context of the embodiment, each user interface object may have associated with it one or more relevant events. Thus, information pertaining to the relevant events associated with an object is also transmitted to the client so that the client may take appropriate action in response to the occurrence of an event. For example, an XML tag associated with a button in a UI screen may include label information about the button and event information indicative of a need to send a message to the server in response to activation of the button by a user manipulating the UI.

At step 240, the method 200 waits for a change event such as associated with the UI screen or some other event. That is, referring to box 245, event detector/transmitter monitors user input via the UI screen to determine if a change event has occurred such as an updated field, data entry event and the like.

Upon the occurrence of a UI screen change event (or other event), at step 250 a determination is made as to the appropriate action to be taken in response to the UI screen event. Referring to box 255, this determination is made by the event detector and transmitter. At step 260, if determined to be appropriate, the UI event data and any accumulated UI field changes and other data are transmitted to the server for further processing.

At step 265, any commands from the server are received and implemented by the client device. Such commands may be sent by the server in response to the data transmitted to the server at step 260, the occurrence of some logical condition within the context of the application and so on. The method 200 then returns to step 240 to wait for the next event data.

FIG. 3 depicts a flow diagram of a server-side method according to one embodiment. Specifically, the method 300 of FIG. 3 is entered at step 310 when the server receives an application request from a client device. At step 315, software code associated with the requested application initial user interface screen, event detector/transmitter and/or action interpreter is transmitted to the requesting client device.

At step 320, the server waits to receive indication from the client device of UI event data and/or UI field change data. At step 325, the event data is processed within the context of the application according to the appropriate logic rules. Referring to box 330, the guiding processing rules are implemented by the action engine. At step 335, the server transmits commands and/or new user interface screen codes and/or other data to the client device executing the application. The method at 300 then returns to step 320 to wait for the next event data.

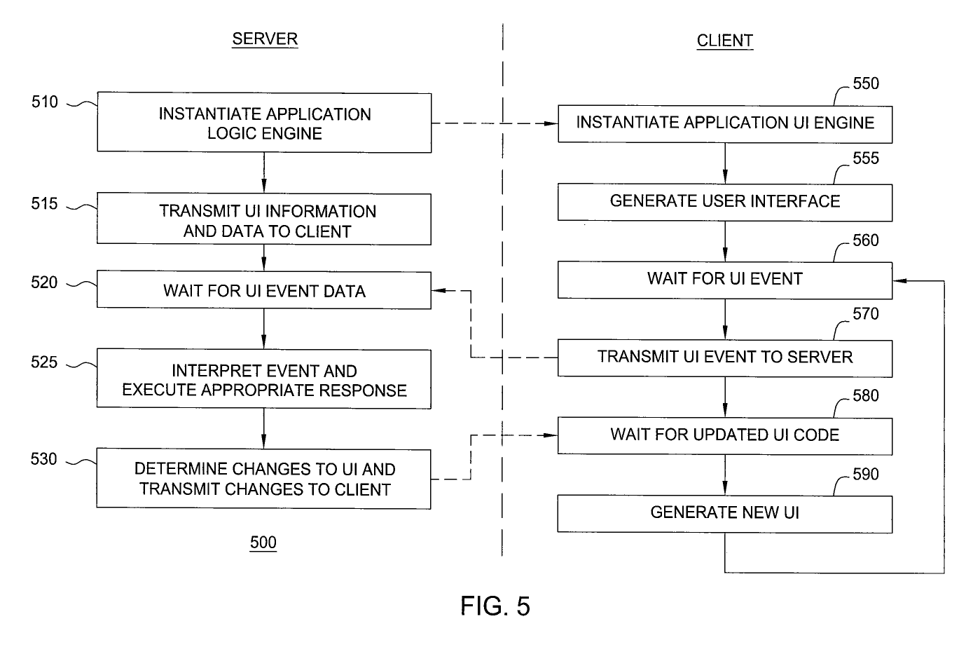

FIG. 5 depicts a flow diagram of a web application methodology according to one embodiment. Specifically, the method 500 of FIG. 5 depicts a plurality of server invoked steps (510-530) and client invoked steps (550-590) within the context of the execution of a web. The server invoked steps and client invoked the steps interact with each other as will now be described.

The server invoked steps of the method 500 of FIG. 5 are entered at step 511 when the server instantiates an application logic engine. That is, the logic or core processing functionality associated with the requested application is instantiated in a server device after the application has been requested by a client device.

At step 515, user interface code as well (as any other commands/data) is transmitted to the requesting client device. That is, code associated with user interface functions (i.e., rather than logic or other application processing code) is transmitted to the requesting client device. In this manner, the requesting client device need only support those functions associated with a user interface, thereby avoiding the computational and transport overhead associated with the support of logic or other core processing functions of the application. In various embodiments, the client device has no knowledge of the particular application of being executed since only user interface functions associated with that application are processed by the client device.

At step 520, the server device waits for a communication from the client device indicative of the occurrence of a user interface event. Upon receiving at the server device an indication of a user interface event, the method 500 proceeds to step 525 where the received UI event is interpreted/processed by the application logic engine, and where an appropriate response to the UI event is determined. Such response may comprise, illustratively, a database update, change or other processing operation, a communication with another entity (node, application and the like), a configuration of a user profile, a selection of another application to be instantiated, or any other server-side functionality that may be invoked within the context of a web application.

At step 530, the server determines the changes/updates to the UI and transmits the changes to the client device for subsequent processing. The above-described steps 510-530 depict server operations within the context of the web application. It is noted that such operations comprise core logic and other application processing operations.

At step 550, the client device receives user interface code from the server and instantiated an application user interface engine. At step 555, the client device generates a user interface screen, such as a graphical user interface for displaying upon a presentation device.

At step 560, the client device waits for a user interface event to occur. Such an event may comprise, as previously noted, a change or selection by a user of an icon, field or other user interface attribute. Upon receiving an indication of a user interface event, the method 500 at step 570 transmits indicia of the UI event to the server.

At step 580, the client device waits to receive updated user interface code from the server. That is, the client device waits for the logic engine within the server to process the previously transmitted UI event data and responsively provide user interface code supporting an updated user interface screen in accordance with the application. Upon receiving at the client updated user interface code, the method 500 proceeds to step 590 where the client generates a new user interface screen, such as a graphical user interface for displayed upon a presentation device. The client-device context then moves to step 560 to wait for a user interface event.

The above-described steps 550-590 depict client operations within the context of the web application. It is noted that such operations comprise user interface generation and detection of events associated with subscriber/user interaction with the generated user interface. It should be noted that while non-UI processing operations are not necessary in various embodiments (such as depicted herein with respect to the method 500 of FIG. 5), the inventors to contemplate such non-UI processing operations in other embodiments. Thus, the various steps may be modified to include waiting for, processing and/or locally responding to non-UI events as well as UI events. Moreover, a client device may optionally process locally UI events that do not require server-side resources.

It is noted that the inventors contemplate that the various embodiments, modifications and permutations of functional elements discussed herein may be combined in accordance with the teachings herein to produce corresponding new embodiments, modifications and permutations of the invention. For example, the server-side logic engine discussed herein with respect to FIG. 5 generally implements the functionality discussed above with respect to the application server 110 of FIG. 1 (e.g., application 116A, application state machine 116ASM, action engine aa6AE, data base 120 and so on). Similarly, the client-side UI code and related functionality (not shown) discussed herein which respect to FIG. 5 generally implements the functionality discussed above with respect to the client 140 of FIG. 1 (e.g., event detection and transmitter 146EDT, action interpreter 146AI, application support 146AS, UI generator 146UIG and so on).

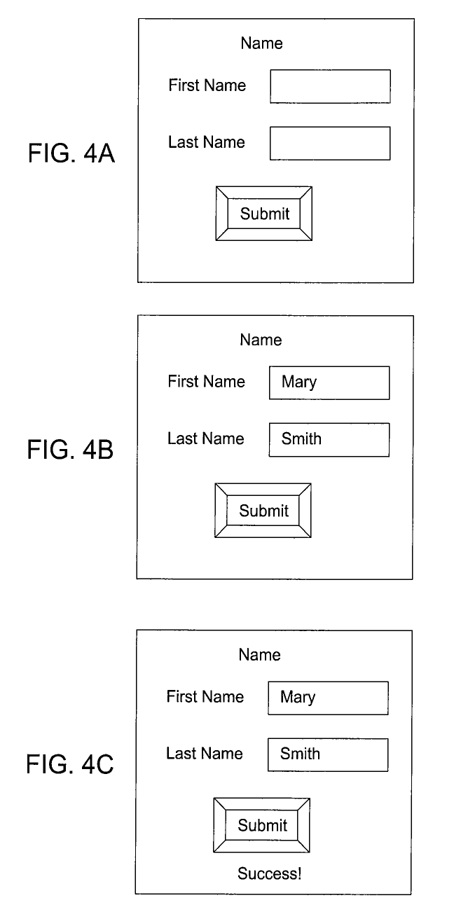

The operation of an embodiment will now be discussed within the context of an example. FIG. 4 depicts various user interface data entry screens useful in understanding the example. Specifically, when a user opens an application, the client machine loads the Event Detector/Transmitter and Action Interpreter. This code resides in the client machine prior to any user interface screens being displayed. The server-side Action Engine passes the initial screen to the client machine as a set of commands. There are various formats that the event transmission may use use. One possible format for the transmission information is extensible markup language (XML), as depicted below.

A user interface screen such as depicted in FIG. 4A may be generated using the following XML code, which is transmitted from the server to the client and adapted to cause the client to produce UI screens having specific visual elements (e.g., color, position, text and the like), which elements may also be associated with specific events (e.g., provide indication to the server if a button is pressed):

```
<actionSet Session = 12345>
    <Screen ID=”1” Title=″Name″ Modal=″Y″ Position=″center″
    Resize=″N″ Height=″200″ Width=″440″ FontData=″Tahoma″
    FontLabel=″Dialog″ FontDataSize=″11″ FontLabelSize=″11″
    FontDataBold=″N″ FontLabelBold=″Y″
    FontDataItalic=″N″ FontLabelItalic=″N″ FontDataColor=″black″
    FontLabelColor=″black″>
        <ScreenElement Type=″Field″ Value=″John″ ID=”111”
        Label=″First Name″ LabelPosition=″Left″ Editable=″Y″
        PositionX=″230″ PositionY=″100″ Width=″80″/>
        <ScreenElement Type=″Field″ Value=″Jones″ ID=”222”
        Label=″Last Name″ LabelPosition=″Left″ Editable=″Y″
        PositionX=″230″ PositionY=″200″ Width=″80″/>
        <ScreenElement Type=″Button″ PositionX=″120″
        PositionY=″300″ Width=″80″ Label=″Submit″
        ID=”333” LabelPosition=″Center″ Event=″Press″/>
  </Screen>
</actionSet>
```

In the above example, the user session is assigned the ID 12345. Information about which object to update in the database is retained by the Action Engine or, optionally, is passed to the client using additional tags. The Action Interpreter processes the above actions and renders the screen shown in FIG. 4A. For purposes of this example it is assumed that a user interacts with the UI screen to change values, click buttons etc. such that the first name and last name fields of the UI screen are populated and the “submit” button is selected, such as depicted with respect to FIG. 4B. Changing values within the first name and last name fields do not trigger an immediate action of reporting to the server. However, in the event of the user activating the “submit” button, the contents of the first name and last name fields are transmitted to the server.

Broadly speaking, the code transmitted to the client includes user interface screen rendering information and related event monitoring information, while notification of the occurrence of an event is transmitted from the client to the server. For example, given the numerous possible interactions of the user with a user interface, only a subset of those interactions are of interest to a Web application (e.g., such as the selection or activation of the UI button) and are considered to be “events.” The code transmitted to the client defines which events are of interest within the context of the application. For some events, the application server must be informed of their occurrence. For other events, the client must take one or more local actions. In either case, the need to notify the server and/or the need to take a local action are conveyed to the client via code transmitted from the server. Thus, for each user interface object transmitted to the client, the relevant events associated with the object are also transmitted so that the client responsively takes appropriate action in response to the occurrence of an event.

In this example, only the submit button has an action defined for it (Event=“Press”) that the Event Detector must handle. Thus, the selection or activation of the “submit” button is detected by the Event Detector/Transmitter on the client machine. This event, along with any fields that have been changed since the last event transmission, is transmitted to the application engine. The event transmission may also be performed using an XML format, such as depicted below. Specifically, in response to the user pressing the “submit” button, the Event Detector/Transmitter notifies the Action Engine of the event. In addition, it is assumed for this example that there were two fields that had been modified since the last event notification. Therefore, the new values for these fields are also included in the event notification string as shown herein:

```
<eventNotification sessionId = “12345”
              ID = “333”
              Event = “Press”>
  <Field ID=”111”>Mary</Field>
  <Field ID=”222”>Smith</Field>
</eventNotification>
```

The Action Engine receives the event notification and responds according to application specific rules stored in the system. In this example, the appropriate customer record is updated in the database. If the context of which record to update is not stored in the Action Engine, then the context information must be passed to the server as part of the event notification.

The action engine interprets the detected event(s) and, based on user interface rules embedded in the action engine, determines which DML operations are required by the event in the database, executes the DML operation, and finally generates a list of actions to be transmitted back to the client. A sample XML representation of this type of action follows. In this example, the database update was successful and the client machine is to be so notified.

```
<actionSet Session = 12345>
    <ScreenUpdate ID=”1”>
        <ScreenElement Type=″Text″ Value=″Success″ ID=”444”
        PositionX=″230″ PositionY=″400″ Width=″80″/>
  </ScreenUpdate>
</actionSet>
```

The actions are transmitted from the Action Engine to the Action Interpreter. The Action Interpreter parses the actions and makes the appropriate update to the screen, as shown in FIG. 4C. The Action Interpreter on the client reads the actions passed from the Action Engine and updates the user interface accordingly.

The invention may operate in several operating modes.

In a first operating mode, the Action Engine maintains a complete copy of the current status of each user's client application, which is then associated with a session identifier. In this mode, each event transmission from the client is sent including the session ID in order to communicate the context to the action engine. This mode minimizes the amount of information transmitted between the client and server.

In the first operating mode, the Event Detector/Transmitter resides on a client machine, having the ability to detect and transmit events to the Action Engine. All changes to the status of the application are transmitted to the Action Engine along with the detected events. In the first operating mode, the current status of the application is stored in the Action Engine so that the Action Engine has information sufficient to determine the appropriate actions.

In a second operating mode, no copy of the application is maintained on the application sever. Instead, the client application passes sufficient information to provide the context necessary for the action engine to determine the appropriate actions. This context information includes database object identifiers to determine which database objects to update.

One embodiment of the invention comprises a method for architecting a web application consisting of a system including an Event Detector/Transmitter, an Action Engine and an Action Interpreter. The Action Engine, residing on a separate computer from the Event Detector/Transmitter receives the event and, using a predefined set of application-specific rules, determines a set of actions that the client should perform. The Action Engine transmits the actions back to the Event Detector/Transmitter. The Action Interpreter residing on the same computer as the Event Detector/Transmitter receives the actions. The Action Interpreter interprets the actions and makes appropriate changes to the user interface. A repository or alternate methodology is used to specify the rules that determine how to generate the appropriate actions.

In one embodiment, performance is improved by sending the UI representation of any page only once. In this embodiment, the UI representation of any page is cached on a client machine for either the duration of a session or in a persistent manner so that UI information need not be resent/reloaded when a user opens the application days or weeks later. Thus, when the present state of an application is such that a previously transmitted UI page should be displayed by the client, the server sends to the client data identifying the previously sent (now cached) UI page. The client uses the identifying data to render/display the cached UI page.

In one embodiment, performance is improved by sending events with only non-data related actions (i.e., those events that do not require information from the database 120) only once. In this embodiment, the non-data related actions are cached on a client machine for either the duration of a session or a persistent manner so that non-data related actions need not be resent/reloaded when a user opens the application days or weeks later.

In one embodiment, network traffic is further reduced by reducing the number of characters used to represent tag and/or attribute names (e.g., reducing the number of characters to one or a very few characters).

The various embodiments of the invention may be implemented within the context of methods, computer readable media and computer program processes. Generally speaking, methods according to the invention may be implemented using computing devices having a processor as well as memory for storing various control programs, other programs and data. The memory may also store an operating system supporting the programs. The processor cooperates with conventional support circuitry such as power supplies, clock circuits, cache memory and the like as well as circuits that assist in executing the software routines stored in the memory. As such, it is contemplated that some of the steps discussed herein as software processes may be implemented within hardware, for example as circuitry that cooperates with the processor to perform various steps. Input/output (I/O) circuitry forms an interface between the various functional elements communicating with the device.

A computing device is contemplated as, illustratively, a general purpose computer that is programmed to perform various control functions in accordance with the present invention, the invention can be implemented in hardware as, for example, an application specific integrated circuit (ASIC) or field programmable gate array (FPGA). As such, the process steps described herein are intended to be broadly interpreted as being equivalently performed by software, hardware or a combination thereof.

The invention may also be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a signal bearing medium such as a broadcast medium, and/or stored within a working memory within a computing device operating according to the instructions.

The subject invention enables a dramatic reduction in required client resources since the particular context of user interaction with application does not need to be “known” to the client. That is, the client facilitates user interaction and other processing functions in a generic manner. The result of this user interaction and other processing functions is interpreted by a non-client mechanism for subsequent action. The only information going to the client is identification of events of interest and a library to determine whether or not an application is concerned with activation of a particular button or function. That is, the function of the button is not known to the client; only that there is something of interest to the engine inherent in the button activation.

When the application differential is passed to the application, the application the information will tell the application about the events of interest that, when detected, need to be sent back to the engine. No other client logic is necessary.

User interface Web applications other than application of this invention (e.g., filling a timesheet information in the like). Standard point-and-click applications in general, such as payroll, document construction or any forms-based application.

While the foregoing is directed to the preferred embodiment of the present invention, other and further embodiments of the invention may be devised without departing from the basic scope thereof, and the scope thereof is determined by the claims that follow.

What is claimed is:

1. A method, comprising:
storing in a server memory an initial state of an application;
transmitting to a client a user interface (UI) page representing the initial application state, the UI page including at least one object having associated with it an event;
processing a notification of the occurrence of an event according to a set of rules;
updating a state of the application in response to the processed notification; and
transmitting to the client a set of actions adapted to be executed by the client to update thereby a UI page.

2. The method of claim 1, wherein the UI page comprises are XML encoded pages.

3. The method of claim 1, wherein the first and updated applications states comprise one or more of variable states, passcodes, permissions, user identifications, documents in progress and session states associated with the requested application.

4. The method of claim 1, wherein:
said initial application state is determined in response to a request from the client for the application.

5. The method of claim 1, further comprising:
receiving, at the client, a UI page including a least one object having associated with it an event;
rendering the UI page; and
transmitting to the server an event notification in response to the detection of a corresponding event.

6. The method of claim 1, wherein:
in the case of an updated application state being associated with a UI page previously sent to the client, transmitting an identification of the previously sent UI page to the client.

7. The method of claim 5, further comprising:
storing in a memory each received UI page; and
in response to receiving an identification of a cached UI page, retrieving the identified UI page from the memory and rendering the retrieved UI page.

8. The method of claim 5, wherein each received UI page is persistently stored by the client.

9. The method of claim 5, further comprising:
storing in a memory events associated with only non-data related actions; and
performing the non-data related action in response to the detection of the corresponding event condition.

10. The method of claim 1, wherein the application comprises one of a web application and a client-server application.

11. A method for implementing a web application, comprising:
instantiating a logic portion of a web application at a server;
transmitting to a client user interface (UI) code adapted to support at least one screen of a user interface portion of the web application;
receiving, at the server, event data indicative of interaction with a user interface screen at the client;
processing the received event data in accordance with the logic portion of the web application; and
transmitting to the client a set of actions adapted to be executed by the client to update thereby a UI page.

12. The method of claim 11, wherein the logic portion of the web application includes an application state machine (ASM) for storing one or more of variable states, passcodes, permissions, user identifications, documents in progress and session states associated with the requested application.

13. The method of claim 12, wherein the logic portion of the web application includes an action engine (AE), for receiving notifications related to client-side events associated with the application, for processing the received notifications in response to a current state of the application and a set of application-specific rules, and for specifying actions to be executed by the client.

14. A software architecture adapted to facilitate a web application, comprising:
a server-side logic engine for storing a current state of an application and providing updated user interface code to a client device in response to changes in a current state of the application;
a client-side event detector, for detecting user interface events;
a client-side event transmitter, for selectively transmitting to the server indications of detected user interface events; and
a client-side action interpreter, for receiving and interpreting action requests from the server.

15. The software architecture of claim 14, wherein:
the logic engine implements a server-side action engine (AE) for receiving notifications related to client-side events associated with the application, for processing the received notifications in response to a current state of the application and a set of application-specific rules, and for specifying actions to be executed by the client.

16. The software architecture of claim 14, wherein the event detector and action interpreter are stored in a client device and activated by the client in response to receiving the client-side action interpreter.

17. The software architecture of claim 14, wherein only those client device UI interactions that require server-side processing are transmitted to the server.

18. The software architecture of claim 14, wherein:
in response to a client request for an application, the architecture supplies to the client code for implementing an initial user interface (UI) function including modifiable fields adapted to receive user information in accordance with the application.

19. A software architecture adapted to facilitate a web application, comprising:
a server-side application state machine (ASM), for storing in a memory a current state of an application;
a server-side action engine (AE) for receiving notifications related to client-side events associated with the application, for processing the received notifications in response to a current state of the application and a set of application-specific rules, and for specifying actions to be executed by the client; and
a client-side code interpreter, for receiving and executing action data provided by the AE.

20. The software architecture of claim 19, wherein only those client device UI interactions that require server-side processing are transmitted to the server.

21. A computer program product wherein computer instructions, when processed by a computer, adapt the operation of the computer to perform a method comprising:
storing in a server memory an initial state of an application;
transmitting to a client a user interface (UI) page representing the initial application state, the UI page including at least one object having associated with it an event;
processing a notification of the occurrence of an event according to a set of rules;
updating a state of the application in response to the processed notification; and
transmitting to the client a set of actions adapted to be executed by the client to update thereby a UI page.
